(19) United States
(12) Patent Application Publication
(10) Pub. No.: US 2025/0379044 A1
(43) Pub. Date: Dec. 11, 2025

(54) SYSTEMS AND METHODS FOR DATA ACQUISITION METHOD SWITCHING

(71) Applicant: DH Technologies Development Pte. Ltd., Singapore (SG)

(72) Inventors: Chang LIU, Richmond Hill (CA); David Michael COX, Toronto (CA)

(73) Assignee: DH Technologies Development Pte. Ltd., Singapore (SG)

(21) Appl. No.: 18/869,593

(22) PCT Filed: May 31, 2023
(86) PCT No.: PCT/IB2023/055590

§ 371 Date: Nov. 26, 2024

Related U.S. Application Data
(60) Provisional application No. 63/347,649, filed on Jun. 1, 2022.

(51) Int. Cl. H01J 49/04; H01J 49/00; H01J 49/42

(52) U.S. Cl. CPC H01J 49/0431; H01J 49/0036; H01J 49/427

(57) ABSTRACT

A method and system of data acquisition in an acoustic ejection mass spectrometer including a plurality of reservoirs, each reservoir containing a sample, the method including scheduling a plurality of ejection events for the plurality of reservoirs, setting an analysis method for each ejection event, ejecting a first sample at a first ejection time, starting a first analysis method of the ejected first sample at a first start time, ejecting a second sample at a second ejection time, and starting a second analysis method of the ejected second sample at a second start time, the second start time being or equal to or earlier than the first end time. For example, before starting the first analysis method, it is determined whether an ejection of the first sample has occurred, and if the ejection of the first sample is determined not to have occurred, the second sample is ejected.

### CROSS-REFERENCE TO RELATED APPLICATIONS

This application is being filed on May 31, 2023, as a PCT International Patent Application that claims priority to and the benefit of U.S. Provisional Application No. 63/347,649, filed on Jun. 1, 2022, the disclosure of which is hereby incorporated by reference in its entirety.

### BACKGROUND

Acoustic Ejection Mass Spectrometry (AEMS) is a high-throughput analytical platform, where nano-liter sized sample droplets, or samples, are ejected acoustically from a sample well plate in a non-contact manner, and captured in an open port interface (OPI). The sample is diluted and transferred from the OPI to a mass spectrometer (MS) for analysis. Each ejection typically generates a one-second baseline wide peak on a standard system setup, which determines the analytical throughput to one well every second, or ˜1 Hz.

### SUMMARY

In one aspect, the technology relates to a method of data acquisition in an acoustic ejection mass spectrometer including a plurality of reservoirs, each reservoir of the plurality of reservoirs containing a sample, the method including scheduling a plurality of ejection events for the plurality of wells, setting an analysis method for each ejection event, ejecting a first sample at a first ejection time, starting a first analysis method of the ejected first sample at a first start time, the first start time being correlated to the first ejection time, the first analysis method having a first end time, ejecting a second sample at a second ejection time, and starting a second analysis method of the ejected second sample at a second start time, the second start time being equal to or earlier than the first end time.

In an example of the above aspect, before starting the first analysis method, the method further includes determining whether an ejection of the first sample has occurred, and when the ejection of the first sample is determined not to have occurred, the method further includes ejecting the second sample before the second ejection time. In another example, determining whether the ejection of the first sample has occurred includes detecting an acoustic wave generated by the ejection of the first sample, and when the detected acoustic wave is below an acoustic threshold, the ejection of the first sample is determined not to have occurred.

In yet another example of the above aspect, setting the analysis method for each ejection event includes setting the analysis method for one or more ejections from a same reservoir. In another example, ejecting the first sample includes ejecting the first sample from a first reservoir, and ejecting the second sample includes ejecting the second sample from a second reservoir. In yet another example, starting the first analysis method includes setting a plurality of first operating parameters of the sample analyzing system, starting the second analysis method includes setting a plurality of second operating parameters of the sample analyzing system, and at least one of the first operating parameters is different from at least one of the second operating parameters.

In another example of the above aspect, the method further includes determining a first delay, wherein starting the first analysis method includes starting the first analysis method based on the first ejection time and the determined first delay. For example, a difference between the first start time and the first ejection time is the first delay; the first delay is determined from one of acoustic log information, a log of the mass spectrometer, and a previous data acquisition run. In another example, the sample analyzing system includes an acoustic ejection mass spectrometry system, and the first delay is determined by performing a calculation based on operating parameters of at least one of a mass spectrometer, an acoustic droplet ejector coupled to the mass spectrometer, and an open port interface coupled to the mass spectrometer. In yet another example, the method further includes determining a second delay, wherein starting the second analysis method includes starting the second analysis method based on the second ejection time and the determined second delay. In an example, the method further includes determining an overlap as being a time difference between the first end time and the second start time; during the overlap, the method includes contemporaneously performing the first analysis method and the second analysis method; and/or the method further includes delaying the second ejecting time by the overlap and starting second analysis method at or after the first end time.

In yet another example of the above aspect, scheduling the plurality of ejection events is based on an analysis duration of the samples; and/or wherein the first ejection time and the second ejection time are separated by the analysis duration of the first sample.

In another example of the above aspect, before scheduling the plurality of ejection events, the method includes measuring a volume of sample in each reservoir of the plurality of reservoirs, and when the measured volume of sample is outside of a predetermined volume range, omitting the reservoir from the scheduling of ejection events.

In another aspect, the technology relates to a sample analyzing system that includes a sample receiver; a mass analysis device fluidically coupled to the sample receiver; a processor operatively coupled to the sample receiver and to the mass analysis device; and a memory coupled to the processor, the memory storing instructions that, when executed by the processor, perform a set of operations. In one aspect, the set of operations includes scheduling a plurality of ejection events for a plurality of reservoirs, setting an analysis method for each ejection event of the plurality of ejection events, ejecting a first sample at a first ejection time, starting a first analysis method of the ejected first sample at a first start time, the first start time being correlated to the first ejection time, the first analysis method having a first end time, ejecting a second sample at a second ejection time, and starting a second analysis method of the ejected second sample at a second start time, the second start time being equal to or earlier than the first end time.

In another example of the above aspects, the set of operations includes, before starting the first analysis method, determining whether an ejection of the first sample has occurred, and when the ejection of the first sample is determined not to have occurred, ejecting the second sample before the second ejection time. As another example, the set of operations includes determining whether the ejection of the first sample has occurred by detecting an acoustic wave generated by the ejection of the first sample, and when the detected acoustic wave is below an acoustic threshold, determining that the ejection of the first sample has not occurred.

In yet another example of the above aspect, the sample analyzing system includes at least one of an acoustic ejector, an ionization chamber, and a mass spectrometer. In yet another example, the set of operations further includes determining a first delay, wherein starting the first analysis method includes starting the first analysis method based on the first ejection time and the determined first delay. In another example, a difference between the first start time and the first ejection time is the first delay. In a further example, the set of operations includes determining the first delay from one of acoustic log information, a log of the mass spectrometer, and a previous data acquisition run. In yet another example, the set of operations includes determining the first delay by performing a calculation based on operating parameters of at least one of the acoustic ejector, the ionization chamber, and the mass spectrometer.

In other examples of the above aspect, the sample receiver includes an open port interface. In a further example, the sample analyzing system further includes a well plate having a plurality of wells, each well corresponding to a reservoir of the plurality of reservoirs and including at least one of the first sample and the second sample. In other example, the well plate includes one of 384 wells and 1536 wells. In another example, the sample analyzing system further includes a non-contact sample ejector, wherein the set of operations further includes receiving the ejected first sample at the sample receiver, and wherein receiving the first sample includes introducing, with the non-contact sample ejector, the first sample from the well plate into the sample receiver. For example, the non-contact sample ejector includes an acoustic droplet ejector. In a further example, the mass analysis device includes at least one of a differential mobility spectrometer (DMS), a mass spectrometer (MS), and a DMS/MS; and/or a frequency of ejecting the first sample and the second sample is greater than 1 Hz.

In another example of the above aspect, the set of operations includes setting the analysis method for each ejection event by setting the analysis method for a plurality of ejections from a same reservoir of the plurality of reservoirs. In a further example, the set of operations includes ejecting the first sample from a first reservoir, and ejecting the second sample from a second reservoir. In yet another example, the set of operations includes starting the first analysis method by setting a plurality of first operating parameters of the mass spectrometer, starting the second analysis method by setting a plurality of second operating parameters of the mass spectrometer, and at least one of the first operating parameters is different from at least one of the second operating parameters.

In yet another example of the above aspect, the set of operations further includes determining a second delay, wherein the set of operations includes starting the second analysis method by starting the second analysis method based on the second ejection time and the determined second delay. In a further example, the set of operations further includes determining an overlap as being a time difference between the first end time and the second start time. In yet another example, the set of operations further includes contemporaneously performing the first analysis method and the second analysis method during the overlap; the set of operations includes determining the overlap based on a length of the first analysis method; and/or the set of operations further includes delaying the second ejecting time by the overlap and starting second analysis method at or after the first end time.

In a further example of the above aspect, the set of operations includes scheduling the plurality of ejection events based on an analysis duration of the samples. In yet another example, the first ejection time and the second ejection time are separated by the analysis duration of the first sample.

In other examples of the above aspect, the set of operations includes before scheduling the plurality of ejection events, measuring a volume of sample in each reservoir of the plurality of reservoirs, and when the measured volume of sample is outside of a predetermined volume range, omitting the reservoir from the scheduling of ejection events.

### BRIEF DESCRIPTION OF THE DRAWINGS

FIG. 1 is a schematic view of an example system combining acoustic droplet ejection (ADE) with an open port interface (OPI) sampling interface and electrospray ionization (ESI) source.

FIG. 2 is a schematic diagram illustrating operation of another particular example system in accordance with various embodiments described herein.

FIG. 3 is a schematic representation of well plate, in accordance with various examples of the disclosure.

FIG. 4 depicts a sequence of data acquisition method switching, according to various examples of the disclosure.

FIG. 5 is a flow chart depicting an example process for data acquisition method switching, in accordance with various embodiments described herein.

FIGS. 6A-6B are flow charts depicting example processes for data acquisition method switching, in accordance with various examples of the disclosure.

FIG. 7 depicts a block diagram of a computing device.

### DETAILED DESCRIPTION

High-throughput sample analysis is typically advantageous to the drug discovery process. Such sample analysis may be performed utilizing bioanalysis technologies that include colorimetric microplate-based readers. Such readers, however, are sometimes constrained by linear dynamic range as well as the need for label attachment schemes which may have the propensity to modify equilibrium and kinetic analysis. Mass spectrometry-based methods can achieve label-free, universal mass detection of a wide range of analytes with improved sensitivity, selectivity, and specificity. For example, AEMS is a high-throughput analytical technology where the OPI is used to capture, dilute, and transfer the acoustically ejected nanoliter-sized sample droplets to the electrospray ionization-mass spectrometry (ESI-MS) for analysis. For a standard system setup, each ejection may generate a one-second baseline-wide signal peak that determines the analytical throughput as 1 Hz (signal could be separated from the interference of adjacent samples). Based on this sampling speed, the MS signal from each ejection may be continuously recorded as a single data file, where the same MS data acquisition method is applied.

However, different target analytes contained in separate wells may be required to be analyzed for some assays, requiring a well-specific MS acquisition method (e.g., different multiple reaction monitoring (MRM), different high resolution multiple reaction monitoring (MRM HR), or a different inclusion list for information dependent acquisition mode (IDA)). Due to the typically narrow peak width of the AEMS signal, the number of experiments or measurements that may be conducted sequentially (e.g. MRM transitions, fragment ion scan for different precursor ions in MRM HR or IDA) within a data point cycle is typically limited to, e.g., 4-6. Accordingly, there is a technical problem in selectively activating only a limited number of experiments or measurements at a given point in time based on the sample being analyzed, particularly when the sample may vary from one well to another.

In order to solve this technical problem, several approaches have been reported, such as activating the experiment based on the expected retention time, or activating the experiment based on the signal appearance of another experiment. However, for AEMS, there is the possibility of the appearance of “bad wells”, and the ejection of these bad wells may be skipped in order to avoid wasting the expected amount of time to measure these bad wells. Bad wells may be defined as those with incorrect or insufficient sample volume, those containing air bubbles or other contaminants, and/or those that may not contain a sufficient amount of the expected analyte. Furthermore, there is typically a delay time between the acoustic ejection event and the appearance of the MS signal, the delay time corresponding to a travel time of the sample through portions of the analyzing apparatus such as, e.g., the OPI. This delay time typically ranges from about 3 to 6 seconds, depending on the system operation parameters, although this delay time variation within the same run may only vary within +300 us. These limitations make the methods listed above less robust.

In view of the above technical problems, technical solutions described in examples of this disclosure provide a method of MS data acquisition where the data acquisition of a specific sample well may be activated by the triggering signal of the acoustic ejection. For example, the acoustic ejection triggering signal containing the information of the well position and the ejection time is sent to the MS data acquisition control module on-the-fly for the activation of the MS methods linked to that sample well. For example, parameters of note may include the start time and duration of the method activation. Because there typically is a 3-6 seconds delay time between the acoustic ejection event and the appearance of the MS signal (as the ejected sample is being transferred through the OPI tube), and this delay time is relatively stable for the given system condition, it may be determined either prior to the run, or at the beginning of the sample test run by using a barcode signal. The start time of each method may then be optimized based on the determined delay time. For example, if the determined delay time is 4 seconds, and the MS signal duration is 1 second, the start time and the duration of the method activation may be set as 3 seconds after the acoustic ejection, and may last for 2 seconds. This method may this overcome the above-discussed issues related to having a “bad well,” or any unexpected ejection time variation from the ADE.

The above discussed examples provide more robust methods of data acquisition because they do not necessarily depend on the real time analysis of the acquired data, nor on the presence of a triggering ion. The example methods use accurate ejection time and reliable signal delay to trigger a desired set of experiments. This enables maximal sample utilization. For example, even when the time from acoustic ejection to MS detection is calibrated, it is typically difficult to know in advance at what time a given sample will be detected since “bad wells” are skipped and not acquired, and it is not always known which wells are “bad wells” prior to the measurement. The example embodiments reduce or eliminate this problem so that the uncertainty in the time a sample is to be acquired is limited only by how accurately the delay time can be calibrated, and not by these “bad wells.”

The technologies described herein may be implemented in MS using acoustic droplet ejection (ADE), and the examples depicted herein are described in that context for clarity. The technologies may also be utilized in systems that use matrix-assisted laser desorption interface (MALDI), other mass analysis techniques using a pneumatic nebulizer as a sample provider, and the like.

Aspects of the technology described herein may also be performed on samples ejected from a sample source such as, e.g., a reservoir or well. For example, the samples may be droplets, gels, solids, and the like. As another example, each sample source may include a plurality of samples that are similar or identical to each other. For example, the sample may be a droplet and the sample source may be the well that contains the droplet as well as many other droplets. Herein, the term “sample” may be used interchangeably to describe both a sample contained in a sample source as well as a portion of that sample that is ejected from the sample source. When concepts such as a “first sample” and a “second sample” are discussed and described herein, the first sample and the second sample may correspond to, e.g., a first droplet and a second droplet contained in the same or a different well or reservoir.

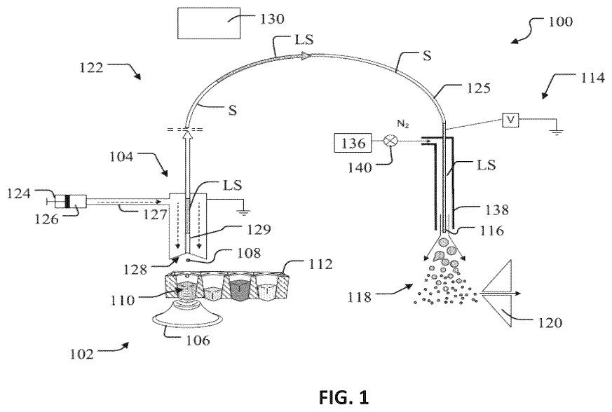

For illustrative purposes, FIG. 1 is a schematic view of an example system 100 combining an ADE 102 with an OPI sampling interface 104 and an ESI source 114, along with a MS 120. Such a system 100 may be referred to as an AEMS system 100. The AEMS system 100 may include a mass analysis instrument such MS 120 for ionizing and mass analyzing analytes received within an open end of the sampling OPI 104. Such a system 100 is described, for example, in U.S. Pat. No. 10,770,277, the disclosure of which is incorporated by reference herein in its entirety. The ADE 102 includes an acoustic ejector 106 that is configured to eject a droplet of sample 108 from a reservoir or well 110 of a well plate 112 into the open end of sampling OPI 104. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (e.g., a MS depicted generally at 120) in communication with the ionization chamber 118 for downstream processing and/or detection of ions generated by the ESI source 114. Due to the configuration of the nebulizer nozzle 138 and electrospray electrode 116 of the ESI source 114, samples ejected therefrom are transformed into small-volume liquid droplets flying in a gas. A liquid handling system 122 (e.g., including one or more pumps 124 and one or more transfer conduits 125) provides for the flow of liquid from a reservoir 126 to the sampling OPI 104 and from the sampling OPI 104 to the ESI source 114. As ESI source 114 allows for the formation of multiple charged ions and are, therefore, more applicable to a variety of applications, they are described within the application for consistency. The technologies described herein, however, may also be utilized for systems that incorporate a plurality of atmospheric pressure chemical ionization (APCI) sources.

In FIG. 1, the reservoir 126 (e.g., containing a liquid, desorption solvent, a sample to be tested, etc.) can be fluidically coupled to the OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in greater detail below, the flow of liquid into and out of the sampling OPI 104 occurs within a sample space accessible at the open end such that one or more droplets of samples 108 can be introduced into the liquid boundary 128 at the sample tip and subsequently delivered to the ESI source 114.

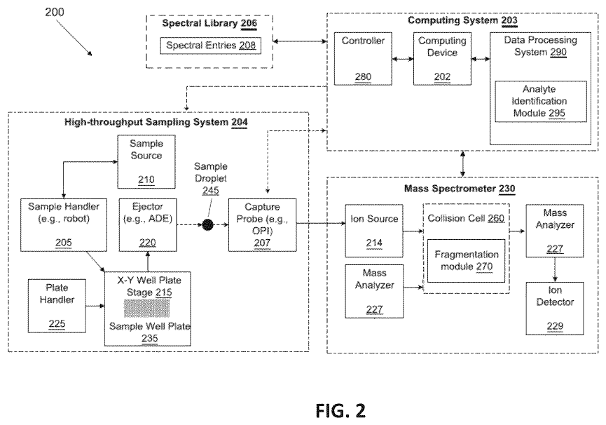

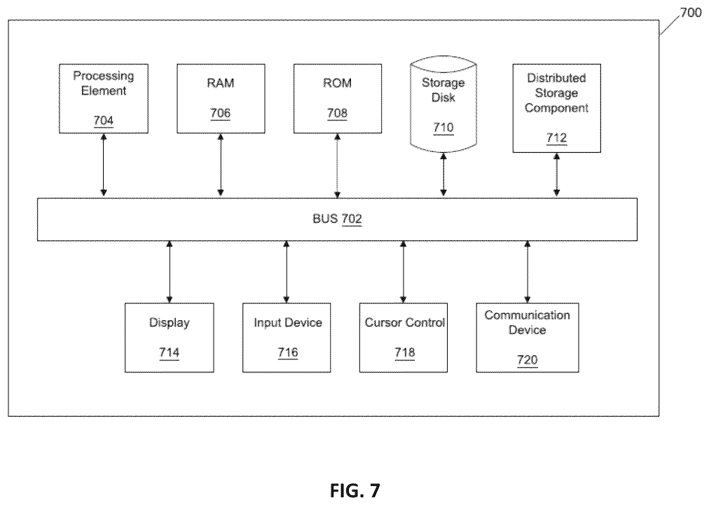

The system 100 includes an ADE 102 that is configured to generate acoustic ejection energy that is applied to a liquid contained within a reservoir 110 that causes one or more droplets of samples 108 to be ejected from the reservoir 110 into the open end of the sampling OPI 104. A controller 130 can be operatively coupled to and configured to operate any aspect of the system 100. This enables the acoustic transducer of the acoustic ejector 106 to inject droplets of samples 108 into the sampling OPI 104 as otherwise discussed herein substantially continuously, or for selected portions of an experimental protocol, by way of non-limiting example. Other types of sample introduction systems, such as, e.g., gravity-based droplet systems, may be utilized. ADE 102 and other non-contact ejection systems may be advantageous because of the high sample throughput that may be achieved. Controller 130 can be, but is not limited to, a microcontroller, a computer, a microprocessor, or any device capable of sending and receiving control signals and data, as described below with respect to the computing device illustrated in, e.g., FIG. 2 or FIG. 7 and discussed below in greater detail. Wired or wireless connections between the controller 130 and the remaining elements of the system 100 are not depicted but would be apparent to a person of skill in the art.

As shown in FIG. 1, the ESI source 114 (when utilized) can include a source 136 of pressurized gas (e.g., nitrogen, air, or a noble gas) that supplies a high velocity nebulizing gas flow to the nebulizer nozzle 138 that surrounds the outlet tip of the electrospray electrode 116. As depicted, the electrospray electrode 116 protrudes from a distal end of the nebulizer nozzle 138. The pressured gas interacts with the liquid discharged from the electrospray electrode 116 to enhance the formation of the sample plume and the ion release within the plume for sampling by mass analyzer detector 120, e.g., via the interaction of the high-speed nebulizing flow and jet of liquid sample (e.g., analyte-solvent dilution). The liquid discharged may include liquid samples LS received from at least one reservoir or well 110 of the well plate 112. The liquid samples LS are diluted with the fluid S, which may also be referred to herein as a transport liquid, and typically separated from other samples by volumes of the fluid S (hence, as flow of the fluid S moves, the liquid samples LS move from the OPI 104 to the ESI source 114). The nebulizer gas can be supplied at a variety of flow rates, for example, a flow rate in a range from about 0.1 L/min to about 40 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect/shock formation). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114.

By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that may be disposed between the ionization chamber 118 and the mass analyzer detector 120 and configured to separate ions based on their mobility difference in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

FIG. 2 is a schematic diagram illustrating the operation of an example system combining acoustic droplet ejection (ADE) with an open port interface (OPI) sampling interface and electrospray ionization (ESI) source. In the illustrated example, the system 200 is operative to perform, e.g., high-throughput mass spectrometry analysis. Similar to the system 100 of FIG. 1, the system 200 includes a sampling system 204, a MS 230, a computing system 203, and optionally a spectral library 206 that may include a plurality of spectral entries 208.

In various aspects, the sampling system 204 may include at least one of a sample source 210 (similar to the reservoir 110 or well plate 112 of FIG. 1), a sample handler 205, a capture probe 207, an X-Y well plate stage 215, an ejector 220, and a plate handler 225. The sample source 210 and the sample handler 205 are operative to retrieve collections of samples from the sample source 210 and to deliver the retrieved collections to capture locations associated with sample capture probe 207. The system 200 may be operative to independently capture selected ones of the plurality of samples at the capture locations, e.g., capture probe 207, to optionally dilute the samples and to transfer the captured samples to MS 230 for mass analysis. In some embodiments, the sample source 210 may include a set of well plates in a storage housing and/or liquid for adding to well plates 235. The sample source 210 may include part of a liquid handling system that manipulates and/or injects liquid into the well plates 235. The sample handler 205 includes one or more electro-mechanical devices (e.g., robotics, conveyor belts, stages, and the like) that are capable of transferring samples (e.g., well plates) from the sample source 210 to other components of the sampling system 204 and/or to other components, such as the ejector 220 and/or the capture probe 207. As an example, the sample handler 205 may transfer a sample well plate 235 to the ejector 220 or the plate handler 225.

In various aspects, the ejector 220 is operable to eject droplets of samples 245 from the wells of the well plate 235. The size of the droplet of sample may typically be from 1 to 25 nanoliters. The ejector 220 may be any type of suitable ejector, such as, e.g., an acoustic ejector, a pneumatic ejector, or another type of contactless ejector. In an example, the plate handler 225 receives a well plate 235 from the sample handler 205. The plate handler 225 transports the well plate 235 to a capture location that may be aligned with the capture probe 207. Once in the capture location, the ejector 220 ejects droplets 245 from one or more wells of the well plate 235. The plate handler 225 may include one or more electro-mechanical devices, such as a translation stage 215 that translates the well plate 235 in an X-Y plane to align wells of the well plate 235 with the ejector 220 and/or or the capture probe 207.

In various aspects, the MS 230 includes at least one of an ion source (e.g., ionization source) 214, a mass analyzer 227, an ion detector 229, and a collision cell 260. The MS 230 can be operative, for example, through use of ion source(s) or generator(s) 214 to produce sample ions of the sample introduced into the MS 230. The collision cell 260 is operative to fragment the precursor ions produced by the ion source 214 to generate product ions (fragment ions) derived from the precursor ions. In various examples, the mass analyzer 227 may be before the collision cell 260. The MS 230 is further operative to filter and detect selected ions of interest from the sample ions through the use of the mass analyzer 227 and ion detector 229. The mass analyzer 227 is operative to analyze the sample ions and produce a mass spectrometry dataset comprising all ion current signals from the sample ions.

In some aspects, the MS 230 is operative to perform tandem mass spectrometry analysis through the use of the collision cell 260. The collision cell 260 may further include a fragmentation module 270 operative to apply an energy to the selected precursor ions and cause the selected precursor ions to undergo fragmentation and generate product ions. The fragmentation module 270 may include at least one of collision induced dissociation (CID), surface induced dissociation (SID), electron capture dissociation (ECD), electron transfer dissociation (ETD), metastable-atom bombardment, photo-fragmentation, or combinations thereof.

It will also be appreciated by a person skilled in the art and in light of the teachings herein that the mass analyzer 227 can have a variety of configurations. Generally, the mass analyzer 227 is operative to process (e.g., filter, sort, dissociate, detect, etc.) sample ions generated by the ion source 214. By way of non-limiting example, the mass analyzer 227 may be a triple quadrupole mass spectrometer, or any other mass analyzer known in the art and modified in accordance with the teachings herein.

In various aspects, the computing system 203 may include a computing device 202 as described above, a controller 280, and a data processing system 290. The controller 280 may be in the form of electronic signal processors and in electrical communication with other subsystems within the system 200. The controller 280 may be operative to coordinate some or all of the operations of the pluralities of the various components of the system 200. In one example, the controller 280 may be a controller for the mass spectrometer 227 and may be used as the primary controller for controlling components in addition to those components housed within the mass spectrometer 227. As such, the controller 280 may be considered the main or central controller that orchestrates, or communicates with, the other controllers to carry out the operations discussed herein in a more efficient manner.

In various aspects, the data processing system 290 may include various components and modules operative to process mass spectrometry data and to provide real-time feedback to users and other subsystems. In some embodiments, the data processing system 290 further includes an analyte identification module 295. The analyte identification module 295 may be operative to perform a library search and predict compound identity of a target analyte in a test sample, optionally through use of the trained machine learning algorithm. In various examples, the computing system 203 may be similar to the computing device 700 described in greater detail below with respect to FIG. 7.

In operation, the sampling system 204 (including sample source 210 and sample handler 205) can iteratively deliver independent samples from a plurality of sample sources (e.g., a droplet from a well of well plate 235) to the capture probe 207. The capture probe 207 can dilute and transport each such delivered sample to the MS 230 disposed downstream of the capture probe 207 for ionizing the diluted sample. The mass analyzer 227 can receive generated ions from the ion source 214 and/or the collision cell 260 for mass analysis. The mass analyzer 227 is operative to selectively separate ions of interest from generated ions received from the ion source 214 and to deliver the ions of interest to the ion detector 229 that generates a mass spectrometer signal indicative of detected ions to the computing system 203. In some aspects, the separate ions of interest may be indicated in an analysis instruction associated with that sample. In some aspects, the separate ions of interest may be indicated in an analysis instruction identified by an indicia physically associated with the plurality of samples.

The system 200 may include a commercial product such as, e.g., a Biomek computer available from Beckman Coulter Life Sciences, which is in operative communication with a MS 230 and a controller for the capture probe 207, which may include, for example, a SCIEX OS computer available from SCIEX. The SCIEX OS computer includes a controller for the capture probe 207, represented for example by SCIEX open port interface software, and a controller for the MS 230, which may be the SCIEX OS computer. The MS 230 and the controller for capture probe 207 may be further in operative communication with an ejector 220 and an X-Y well plate stage 215, which may be, for example, a liquid droplet ejector with embedded computer or processor. For the purposes of this disclosure, these distributed controller components may collectively be considered to be a system controller, and depending upon the configuration, may be centralized or distributed as is the case here. For instance, one of the controllers or controller components may send signals to the other controllers to control the respective devices.

In one particular example, the high-throughput system 200 employs the ADE-OPI-MS technology. The ADE-OPI-MS system according to the present disclosure relies on acoustic dispensing of droplets of samples directly from the wells of the plate or sample source under analysis. The acoustically dispensed droplets of samples, which are typically at nanoliter scale, with precise control and independent of the sample solvent, are acoustically ejected from the ejected sample and introduced to a vortex at the opening of the OPI and delivered directly to the ionization source of the MS for detection. The substantially small samples required, coupled with the method's resilience in handling unpurified samples, make this technology advantageous for direct sampling from the well plate or sample source. The ADE-OPI-MS system and method also offer significant speed advantages: with an average analysis time of 1-2 seconds per sample and a small quantity of 1-10 nanoliter per sample, such that a typical well plate containing 384 wells can be analyzed in under 15 min. Thus, the ADE-OPI-MS system advantageously enables high-throughput analysis of a large quantity of samples and generate a large volume of data within a meaning time frame such as a day. In addition, the ADE-OPI is compatible with both nominal and high-resolution mass spectrometers, allowing rapid quantification with the former, and extensive analyte identification with the latter. It should be noted that although the MS 230 is discussed herein, principles of the above embodiments may be applicable to any other mass analyzing device, or to any sample detection device.

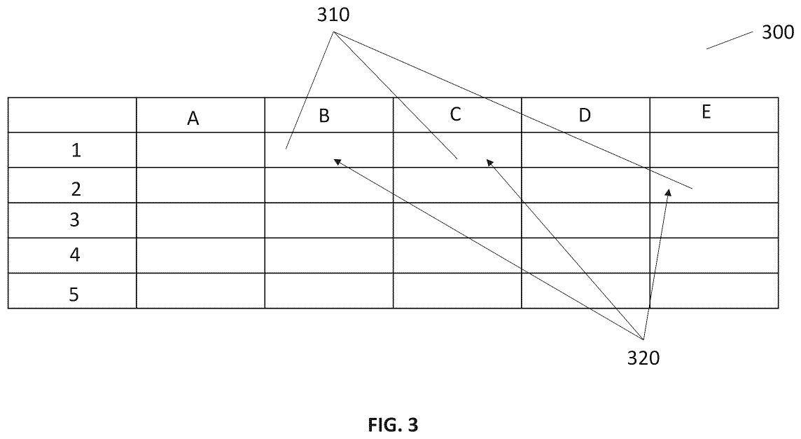

FIG. 3 depicts a well plate, in accordance with various examples of the disclosure. In FIG. 3, a well plate 300 includes a plurality of wells 310, and each well 310 may be similar to a reservoir or well 110 of well plate 112 discussed above with respect to FIG. 1. For example, each well plate may include one or more samples. The depiction of the well plate 300 is schematic and is provided to illustrate the various wells 310. Actual well plates may differ in shape, size and configuration without departing from the concept illustrated herein. During operation of an AEMS system such as the AEMS system 100 discussed above, samples from one or more of the wells 310 may be ejected from the wells 310 and into the OPI such as, e.g., the OPI 104 discussed above. In various examples, each well 310 may include one or more analytes, and each of the analytes may require a different analysis method. In examples, each well 310 may be assigned an analysis method, designated in FIG. 3 with arrow 320, targeted to an analyte present therein. In examples, prior to the start of a data acquisition cycle, the well plate 300 is mapped out so that each well 310 has a corresponding predetermined analysis method designated by the arrow 320 that is directed to analyzing or detecting the analyte present in the well 310. In examples, each analysis method designated by the arrow 320 may include one or more MS data acquisition methods that may be triggered together. In various examples, the analysis methods designated by the arrow 320 for different wells 310 may be the same or different. For example, well B1 may be assigned a different analysis method than well C1 and/or well E2 because the sample or analyte held or targeted in well B1 may be different from the sample or analyte held or targeted in wells C1 and/or E2. Although only three wells 310 are illustrated as having a method designated by arrow 320 assigned thereto, each of the wells A1-E5 may have a unique method assigned thereto. Any two wells may have the same method, or a different method, assigned thereto.

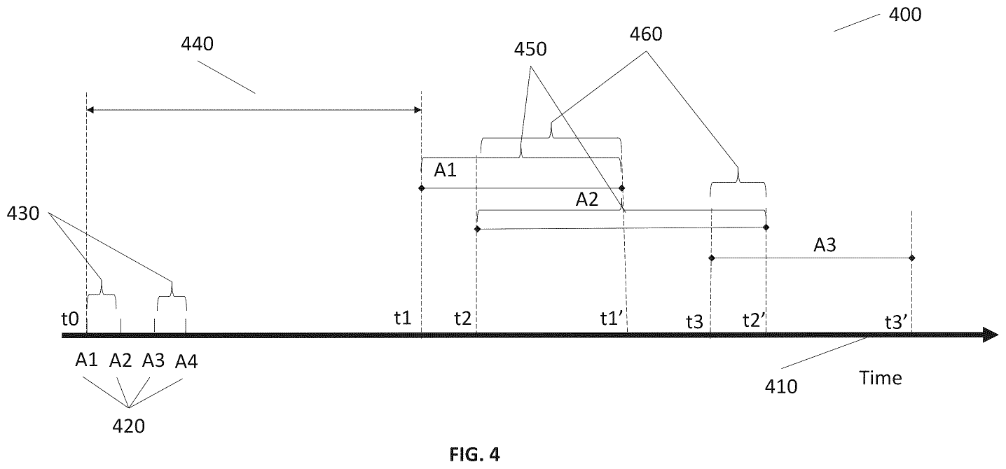

FIG. 4 depicts a sequence of data acquisition method switching, according to various examples of the disclosure. In FIG. 4, along the time axis 410, the sequence 400 starts with the ejection 420 of a first sample from well A1 at time to, the well A1, as well as wells A2, A3 and A4, are described above with respect to FIG. 3. In various examples, as successive ejections 420 of samples from wells A2, A3 and A4 take place, these successive ejections are separated by time intervals 430. For example, the time intervals 430 may correspond to at least a portion of the time necessary for the analysis of the analyte(s) present in the sample ejected from the preceding well. For example, the ejection of a sample from well A2 may be delayed by a period of, e.g., 1.5 s, from the ejection of a sample from well A1, the time interval 430 being, in this case, 1.5 s. Similarly, successive ejections of samples from wells A3 and A4 may be delayed by a duration of, e.g., 1.5 s. Although a delay of 1.5 s is discussed here, other delays may be applicable based on a variety of factors such as, e.g., the type of analyte, the type of analysis method, and the like.

In various examples, following the ejection of a first sample from well A1, the analysis of the first sample ejected from the same well A1, or of the analyte present in the sample ejected from the same well A1, may start at time t1. For example, the interval between times t1 and t0 may correspond to a time of travel 440 of the first sample from well A1 to a sample analyzer through components of a sample analyzing system. For example and with reference to FIG. 1, the time of travel 440 may correspond to a time of travel of sample 108 from the well plate 112, through the sampling OPI 104 and the transfer conduit 125, and out of the nebulizer nozzle 138 to the mass analyzer detector 120. In various examples, at time t1, the analysis method specific to the first sample ejected from well A1 starts taking place. For example, the analysis method may be previously determined specifically to the well A1, as discussed above with respect to FIG. 3. The analysis method of the first sample ejected from well A1 may start at time t1, and may last for a duration of time 450 until end time t1′.

In various examples of the disclosure, as the ejection of a second sample from well A2 takes place, e.g., about 1.5 s after time to, which may be during the time of analysis of the first sample ejected from well A1, the second sample may travel through the analyzing system, as described above with respect to the first sample, and the analysis of the second sample may start at time t2. In various examples, time t2 is earlier than the end time t1′ of the analysis of the first sample. Accordingly, there may be an overlap 460 between the analysis durations 450 of the samples ejected from wells A1 and A2, during which both analyses are concurrently taking place. In various examples, the analysis of the samples ejected from wells A1 and A2 may be the same, or different, depending on the type of analyte being analyzed in each sample. Once the analysis of the first sample ejected from well A1 is completed, at time t1′, the only sample being analyzed is the second sample ejected from well A2. In other examples, time t2 may be at the same time as end time t1′.

In various examples, following the ejection of the second sample from well A2, the analysis of the second sample or analyte present therein ejected from well A2 may start at time t2. For example, the interval between times t2 and the ejection time of the sample from well A2 may correspond to another time of travel of the second sample from well A2 to the sample analyzer through components of the sample analyzing system, as described above with respect to the sample ejected from well A1. In various examples, at time t2, the analysis method specific to the second sample ejected from well A2 starts taking place. For example, this analysis method may be previously determined specifically for the well A2, as discussed above with respect to FIG. 3. The analysis method of the second sample may start at time t2 and last for the duration 450 until end time t2′, where the analysis of the second sample may end.

In various examples, similarly to the successive ejection of the second sample from well A2 following the ejection of the sample from well A1, successive ejections from the remaining wells of the well plate may take place such as, e.g., wells A3 and A4 and others, each ejection being followed by an analysis of the specific sample or analyte that was ejected from each well after a time delay corresponding to a time of travel of the sample through components of the sample analyzing system. In examples, the analysis of each sample may take place at a time corresponding to the ejection time of the sample and the time of travel of the sample through the sample analyzing system. In FIG. 4, for example, t3 illustrates the start of the analysis method for a third sample ejected from well A3, which is before the end time of analysis t2′ of the sample ejected from well A2. As such, there is an overlap 460 during which both the analysis method for the second sample ejected from well A2 and the analysis method for the third sample ejected from well A3 are taking place concurrently. Once the analysis method for the second sample ejected from well A2 has concluded at t2′, then only the analysis method for the third sample ejected from well A3 is taking place. In various examples, a similar succession of ejection, delay, and analysis of the samples ejected from each successive well may take place until all the samples from all the desired wells of the well plate are analyzed. In examples, the desired wells may include a subset of the total number of wells of the well plate.

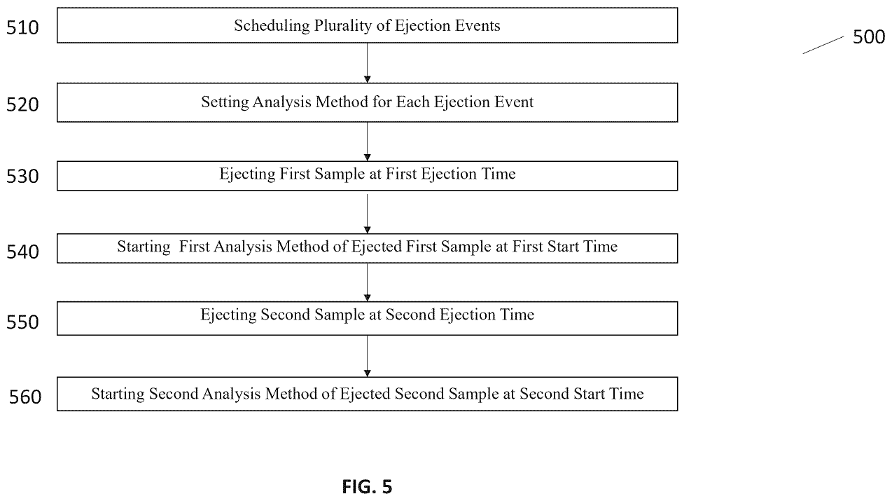

FIG. 5 is a flow chart depicting an example method 500 for data acquisition method switching in a sample analyzing system having a plurality of reservoirs, each reservoir containing a sample, in accordance with various examples of the disclosure. For the sole purpose of convenience, method 500 is performed through use of the example AEMS system 100 or 200 described above. However, it is appreciated that the method 500 may be performed by any suitable system such as, e.g., MALDI, or other mass analysis techniques using a pneumatic nebulizer as a sample provider. In other examples, method 500 may be performed through the use of a mass analysis device including, e.g., a differential mobility spectrometer (DMS), a mass spectrometer (MS), and/or a DMS/MS.

In various examples, operation 510 includes scheduling a plurality of ejection events for samples held in reservoirs or wells from, e.g., a non-contact sample ejector. For example, operation 510 includes scheduling the plurality of ejection events for the wells or reservoirs based on an analysis duration of the samples in each well or reservoir. In an example, operation 510 includes, for successive wells or reservoirs, separating successive ejection times by an interval corresponding to the analysis duration of the samples. As another example, the reservoirs may be wells included in the well plate of an ADE such as ADE 102 discussed above with respect to FIG. 1. As yet another example, an ejection event may be a single ejection, but the ejection event may also be a plurality of ejections from the same reservoir. During operation 520, in various examples, an analysis method is set for each ejection event. For example, the analysis method may be set for a single ejection, or the same analysis method may be set for a plurality of ejections from the same reservoir. In another example, operation 520 includes setting a predetermining analysis method for each well or reservoir in advance of ejecting the samples to be analyzed. Accordingly, neighboring wells or reservoirs may have a same or different analysis method assigned thereto, depending on the analyte or sample held in each well or reservoir.

In other examples of the disclosure, during operation 530, a first sample is ejected at a first ejection time. For example, the first sample may be ejected from a first reservoir or well via, e.g., a non-contact sample ejector. With respect to FIG. 1, the ejected first sample may be received at an interface such as, e.g., the OPI 104 discussed above. For example, during operation 530, the first sample may be ejected from a reservoir such as, e.g., reservoir 110 discussed above, at a first ejection time. In another example such as the AEMS 100 discussed above, the first sample may be contained in a well, the well being one of a number of wells in a well plate such as well plate 112. For example, the well plate may include 384 wells or 1536 wells. Also, the first sample being ejected during operation 530 may be a portion of a larger sample source that is contained in the same well or reservoir. In other examples, the sample analyzing system may receive the first sample at a matrix-assisted laser desorption interface or at a pneumatic nebulizer interface. In another example, operation 530 includes detecting whether an ejection has occurred by measuring a reflection of an acoustic wave generated by the ejection. For example, if the measured reflection of the acoustic wave is below an acoustic threshold, then the ejection of the first sample is determined not to have occurred. In other examples, for an AEMS such as AEMS 100 discussed above, when the first sample is ejected, the ejected first sample may be received at a sample receiver, so that operation 530 includes introducing, with the non-contact sample ejector, the first sample from the well plate into the sample receiver. The non-contact sample ejector may include, e.g., an acoustic droplet ejector.

During operation 540, the method 500 includes starting a first analysis method of the ejected first sample at a first start time. For example, the first start time may be correlated to the first ejection time, and the first analysis method has a first end time. In another example, the first start time may be set based on a received acoustic ejection signal indicating that the first sample has been ejected. For example, to start the first analysis method, operation 540 includes setting a plurality of first operating parameters of the sample analyzing system. For example, the first operating parameters of the sample analyzing system may include an acoustic ejection energy, a volume of the first sample, other operating parameters of, e.g., the ionization chamber, the mass spectrometer and/or the acoustic ejector in the case of an acoustic ejection mass spectrometry system, and the like. In another example, operation 540 includes determining a first delay and starting the first analysis method based on both the first ejection time and the first delay. In examples, the difference between the first start time of the analysis method and the first ejection time of the sample may be the first delay, and the first delay may be determined from, e.g., acoustic log information and a log of the sample analyzing system. In other example, the first delay may be determined from a previous data acquisition run. In examples of the disclosure, when the sample analyzing system is an acoustic ejection mass spectrometry system, the first delay may be determined by performing a calculation based on operating parameters of the mass spectrometer, the acoustic droplet ejector, and/or the open port interface.

During operation 550, a second sample is ejected at a second ejection time. For example, the second sample may be ejected from a second reservoir or well. As another example, a frequency of ejection of the first sample or the second sample may be equal to or greater than 1 Hz. In another example, the second ejection time is correlated to a duration of the analysis of the first sample. In yet another example, the first ejection time and the second ejection time may be separated by a duration of analysis of the first sample.

In further examples of the method 500, operation 560 includes starting a second analysis method of the ejected second sample at a second start time, the second start time being equal to or earlier than the first end time. For example, operation 560 includes setting a plurality of second operating parameters of the sample analyzing system, the operating parameters including, e.g., an acoustic ejection energy, a volume of the first sample, other operating parameters of, e.g., the ionization chamber, the mass spectrometer and/or the acoustic ejector in the case of an acoustic ejection mass spectrometry system, and the like.

In other examples, at least one of the first operating parameters of the sample analyzing system is different from at least one of the second operating parameters of the sample analyzing system. In another example, operation 560 includes determining a second delay and starting the second analysis method based on both the second ejection time and the second delay. In examples, the difference between the second start time and the second ejection time may be the second delay, and the second delay may be determined from, e.g., acoustic log information and a log of the sample analyzing system. In other example, the second delay may be determined from a previous data acquisition run. In examples of the disclosure, when the sample analyzing system is an acoustic ejection mass spectrometry system, the second delay may be determined by performing a calculation based on operating parameters of the mass spectrometer, the acoustic droplet ejector, and/or the open port interface. In an example, the second delay is substantially equal to the first delay.

In various examples of the disclosure, operation 560 may also include determining an overlap between the first analysis method and the second analysis method, the overlap being a time difference between the first end time and the second start time. In examples, during the overlap, the method 500 performs both the first analysis method and the second analysis method concurrently. In other examples, operation 560 includes delaying the second ejection time by the overlap and starting the second analysis method at or after the first end time.

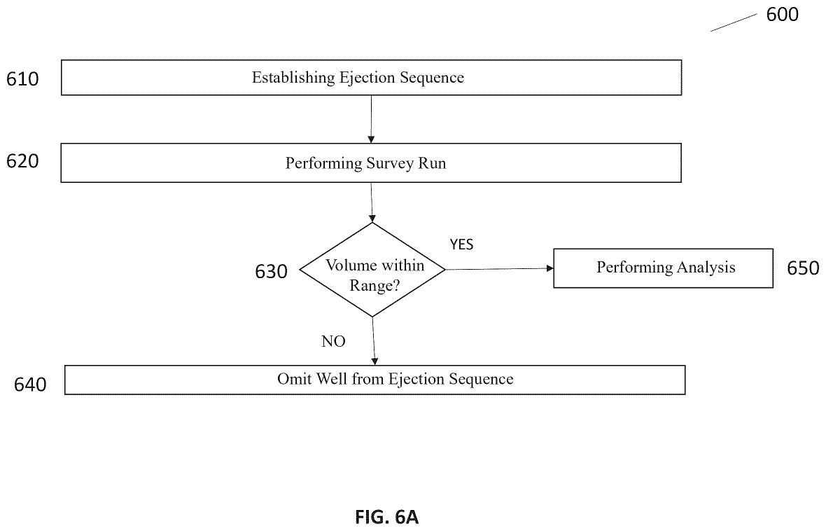

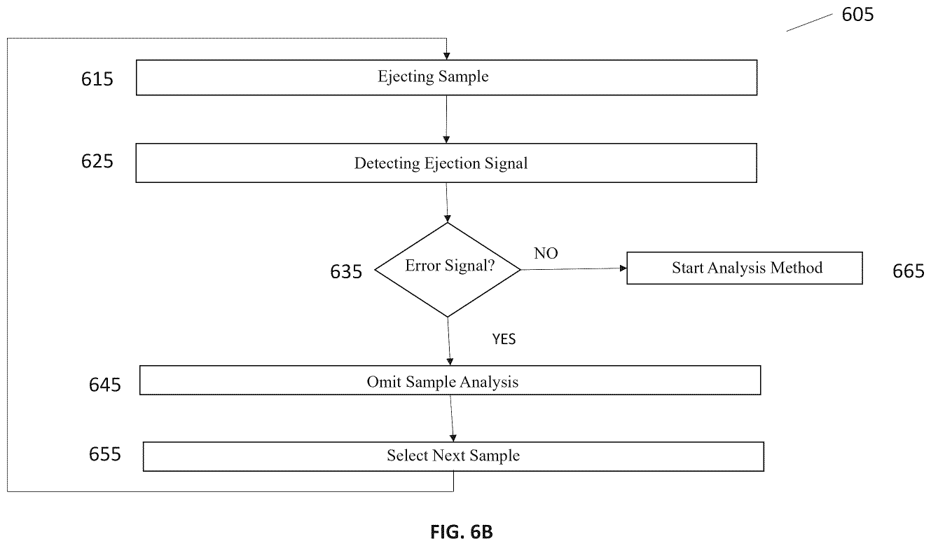

FIGS. 6A-6B are flow charts depicting example processes for data acquisition method switching, in accordance with various examples of the disclosure. In FIG. 6A, the method 600 starts at operation 610 which includes establishing an ejection sequence for the wells of the well plate. For example, operation 610 may be similar to the operation 510 discussed above with reference to FIG. 5.

In various examples, operation 620 includes performing a survey run. For example, performing a survey run includes measuring the volumes of each of the wells in the well plate in order to determine whether the measured volumes are within an acceptable range. In various aspects, measuring the volume of sample in each well may be performed by relying on a time-of-flight (TOF) measurement of the acoustic signal reflected from the sample-air interface, or surface meniscus, and determining the volume of samples in each well on that basis.

In other examples, operation 630 includes comparing the volume of each well measured during operation 620 to a volume range. For example, the volume range may be predetermined and may correspond to a volume that allows the analysis method to be properly performed. As an example, the volume range for a given analysis method may be, e.g., 20-65 ml. In examples, if the volume of a given well that is measured during operation 620 is outside of the predetermined time volume range, then during operation 640, the well is omitted form the ejection sequence established during operation 610. In various examples, the sample volume measured during operation 620 being outside of the predetermined threshold is interpreted as the sample being in some manner compromised, corrupted, or damaged. Accordingly, the sample may be omitted from the ejection sequence for being damaged. As such, by avoiding squandering the time necessary to analyze damaged or corrupted samples or wells, the analysis of a plurality of samples in a plurality of wells may be more efficiently and more rapidly performed. If during operation 630, the measured volume of the sample is within the predetermined volume range, then the sample is not removed from the ejection sequence, and the method 600 proceeds to operation 650 and perform the analysis method on the well plate once all the wells of the well plate have been surveyed. For example, operation 650 may be similar to operations 540 or 560 discussed above with respect to FIG. 5.

FIG. 6B is a flow chart depicting an example process for data acquisition method switching, in accordance with various examples of the disclosure. In FIG. 6B, the method 605 includes ejecting a sample during operation 615. For example, operation 615 may be similar to operation 530 discussed above with respect to FIG. 5. When the sample such as, e.g., a first sample, is ejected during operation 615, an ejection signal such as, e.g., an acoustic ejection signal, is detected during operation 625. In various examples, the ejection signal may be indicative of whether the ejection has actually occurred. During operation 635, a determination is made whether the ejection signal includes an error signal, which may be a signal that the ejection of the sample did not occur. In various examples, if operation 635 determines that the ejection signal of the sample such as, e.g., the acoustic ejection signal of the sample, includes an error signal, then during operation 645, the analysis of the sample is omitted, and during operation 655, the next sample is selected such as, e.g., a sample from the next well in the well plate. When the next sample is selected for ejection during operation 655, the method 605 continues back to operation 615 to eject the next selected sample. In other examples, if operation 635 determines that there is no error signal in the ejection signal, then during operation 665, the analysis method of the sample is started. For example, operation 665 may be similar to operations 540 or 560 discussed above with respect to FIG. 5. As a result, the analysis of any samples that are deemed to be degraded or corrupted, or that may include defects such as, e.g., unwanted air bubbles, may be omitted, which may save time and resources.

FIG. 7 depicts a block diagram of a computing device similar to the computing device 202 discussed above with respect to FIG. 2. In the illustrated example, the computing device 700 may include a bus 702 or other communication mechanism of similar function for communicating information, and at least one processing element 704 (collectively referred to as processing element 704) coupled with bus 702 for processing information. As will be appreciated by those skilled in the art, the processing element 704 may include a plurality of processing elements or cores, which may be packaged as a single processor or in a distributed arrangement. Furthermore, a plurality of virtual processing elements 704 may be included in the computing device 700 to provide the control or management operations for, e.g., the mass analysis systems 100 and 200 illustrated above.

The computing device 700 may also include one or more volatile memory (ies) 706, which can for example include random access memory (ies) (RAM) or other dynamic memory component(s), coupled to one or more busses 702 for use by the at least one processing element 704. Computing device 700 may further include static, non-volatile memory (ies) 708, such as read only memory (ROM) or other static memory components, coupled to busses 702 for storing information and instructions for use by the at least one processing element 704. A storage component 710, such as a storage disk or storage memory, may be provided for storing information and instructions for use by the at least one processing element 704. As will be appreciated, the computing device 700 may include a distributed storage component 712, such as a networked disk or other storage resource available to the computing device 700.

The computing device 700 may be coupled to one or more displays 714 for displaying information to a user. Optional user input device(s) 716, such as a keyboard and/or touchscreen, may be coupled to Bus 702 for communicating information and command selections to the at least one processing element 704. An optional cursor control or graphical input device 718, such as a mouse, a trackball or cursor direction keys for communicating graphical user interface information and command selections to the at least one processing element. The computing device 700 may further include an input/output (I/O) component, such as a serial connection, digital connection, network connection, or other input/output component for allowing intercommunication with other computing components and the various components of, e.g., the mass analysis systems 100 and 200 discussed above.

In various embodiments, computing device 700 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of, e.g., the mass analysis systems 100 and 200 may be supported by operation of the distributed computing systems.

The computing device 202 discussed above with respect to FIG. 2, similar to the computing device 700, may be operative to control operation of the components of the mass analysis system 200 and the sampling system 204 through a communication device such as, e.g., communication device 720, and to handle data generated by components of the mass analysis system 200 through the data processing system 200. In some examples, analysis results are provided by the computing device 700 in response to the at least one processing element 704 executing instructions contained in memory 706 or 708 and performing operations on data received from the mass analysis system 200. Execution of instructions contained in memory 706 and/or 708 by the at least one processing element 704 can render, e.g., the mass analysis systems 100 and 200 and associated sample delivery components operative to perform methods described herein.

The term “computer-readable medium” as used herein refers to any media that participates in providing instructions to the processing element 704 for execution. Such a medium may take many forms, including but not limited to, non-volatile media, volatile media, and transmission media. Non-volatile media includes, for example, optical or magnetic disks, such as disk storage 710. Volatile media includes dynamic memory, such as memory 706. Transmission media includes coaxial cables, copper wire, and fiber optics, including the wires that include bus 702.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 704 for execution. For example, the instructions may initially be carried on the magnetic disk of a remote computer. The remote computer can load the instructions into its dynamic memory and send the instructions over a telephone line using a modem. A modem local to computing device 700 can receive the data on the telephone line and use an infra-red transmitter to convert the data to an infra-red signal. An infra-red detector coupled to bus 702 can receive the data carried in the infra-red signal and place the data on bus 702. Bus 702 carries the data to memory 706, from which the processing element 704 retrieves and executes the instructions. The instructions received by memory 706 and/or memory 708 may optionally be stored on storage device 710 either before or after execution by the processing element 704.

In accordance with various embodiments, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of data acquisition in a sample analyzing system comprising a plurality of reservoirs, each reservoir of the plurality of reservoirs containing a sample, the method comprising:
scheduling a plurality of ejection events for the plurality of reservoirs;
setting an analysis method for each ejection event of the plurality of ejection events;
ejecting a first sample at a first ejection time;
starting a first analysis method of the ejected first sample at a first start time, the first start time being correlated to the first ejection time, the first analysis method having a first end time;
ejecting a second sample at a second ejection time; and
starting a second analysis method of the ejected second sample at a second start time, the second start time being equal to or earlier than the first end time.

2. The method of claim 1, wherein:
before starting the first analysis method, the method further comprises determining whether an ejection of the first sample has occurred by detecting whether an acoustic wave is above or below an acoustic threshold; and
when the ejection of the first sample is determined not to have occurred, the method further comprises ejecting the second sample before the second ejection time.

3. (canceled)

4. (canceled)

5. The method of claim 1, wherein:
ejecting the first sample comprises ejecting the first sample from a first reservoir; and
ejecting the second sample comprises ejecting the second sample from a second reservoir.

6. The method of claim 1, wherein;
starting the first analysis method comprises setting a plurality of first operating parameters of the sample analyzing system;
starting the second analysis method comprises setting a plurality of second operating parameters of the sample analyzing system; and
at least one of the first operating parameters is different from at least one of the second operating parameters.

7. The method of claim 1, further comprising:
determining a difference between the first start time and the first ejection time, defining a first delay;
wherein starting the first analysis method comprises starting the first analysis method based on the first ejection time and the determined first delay.

8. (canceled)

9. (canceled)

10. (canceled)

11. The method of claim 1, further comprising:
determining a second delay;
wherein starting the second analysis method comprises starting the second analysis method based on the second ejection time and the determined second delay.

12. The method of claim 1, further comprising:
determining an overlap as being a time difference between the first end time and the second start time;
during the overlap, contemporaneously performing the first analysis method and the second analysis method; and
delaying the second ejection time by the overlap and starting the second analysis method at or after the first end time.

13. (canceled)

14. (canceled)

15. The method of claim 1, wherein scheduling the plurality of ejection events is based on an analysis duration of the samples, and wherein the first ejection time and the second ejection time are separated by the analysis duration of the first sample.

16. (canceled)

17. The method of claim 1, wherein before scheduling the plurality of ejection events, the method comprises:
measuring a volume of sample in each reservoir of the plurality of reservoirs; and
when the measured volume of sample is outside of a predetermined volume range, omitting the reservoir from the scheduling of ejection events.

18. A sample analyzing system comprising:
a sample receiver;
a mass analysis device fluidically coupled to the sample receiver;
a processor operatively coupled to the sample receiver and to the mass analysis device; and
a memory coupled to the processor, the memory storing instructions that, when executed by the processor, perform a set of operations comprising:
scheduling a plurality of ejection events for a plurality of reservoirs;
setting an analysis method for each ejection event of the plurality of ejection events;
ejecting a first sample at a first ejection time;
starting a first analysis method of the ejected first sample at a first start time, the first start time being correlated to the first ejection time, the first analysis method having a first end time;
ejecting a second sample at a second ejection time; and
starting a second analysis method of the ejected second sample at a second start time, the second start time being equal to or earlier than the first end time.

19. The sample analyzing system of claim 18, wherein the set of operations comprises:
before starting the first analysis method, determining whether an ejection of the first sample has occurred by detecting an acoustic wave generated by the ejection of the first sample; and
when the detected acoustic wave is below an acoustic threshold, determining that the ejection of the first sample has not occurred and ejecting the second sample before the second ejection time.

20. (canceled)

21. (canceled)

22. The sample analyzing system of claim 21, wherein the set of operations further comprises:
determining a first delay;
wherein starting the first analysis method comprises starting the first analysis method based on the first ejection time and the determined first delay defined as a difference between the first start time and the first ejection time.

23. (canceled)

24. (canceled)

25. (canceled)

26. The sample analyzing system of claim 18, wherein the sample receiver comprises an open port interface.

27. (canceled)

28. (canceled)

29. The sample analyzing system of claim 27, further comprising a non-contact sample ejector;
wherein the set of operations further comprises receiving the ejected first sample at the sample receiver; and
wherein receiving the first sample comprises introducing, with the non-contact sample ejector, the first sample from the well plate into the sample receiver.

30. The sample analyzing system of claim 29, wherein the non-contact sample ejector comprises an acoustic droplet ejector.

31. (canceled)

32. (canceled)

33. The sample analyzing system of claim 18, wherein the set of operations comprises setting the analysis method for each ejection event by setting the analysis method for a plurality of ejections from a same reservoir of the plurality of reservoirs.

34. The sample analyzing system of claim 18, wherein the set of operations comprises:
ejecting the first sample from a first reservoir; and
ejecting the second sample from a second reservoir.

35. The sample analyzing system of claim 18, wherein the set of operations comprises:
starting the first analysis method by setting a plurality of first operating parameters of the mass spectrometer;
starting the second analysis method by setting a plurality of second operating parameters of the mass spectrometer; and
at least one of the first operating parameters is different from at least one of the second operating parameters.

36. The sample analyzing system of claim 18, wherein the set of operations further comprises:
determining a second delay;
wherein the set of operations comprises starting the second analysis method by starting the second analysis method based on the second ejection time and the determined second delay.

37. The sample analyzing system of claim 18, wherein the set of operations further comprises:
determining an overlap as being a time difference between the first end time and the second start time based on a length of the first analysis method;
contemporaneously performing the first analysis method and the second analysis method during the overlap;
delaying the second ejecting time by the overlap and starting the second analysis method at or after the first end time; and
scheduling the plurality of ejection events based on an analysis duration of the samples,
wherein the set of operations comprises:
before scheduling the plurality of ejection events, measuring a volume of sample in each reservoir of the plurality of reservoirs; and
when the measured volume of sample is outside of a predetermined volume range, omitting the reservoir from the scheduling of ejection events.

38. (canceled)

39. (canceled)

40. (canceled)

41. (canceled)

42. (canceled)

43. (canceled)
